(19) United States
(12) Patent Application Publication
(10) Pub. No.: US 2005/0074271 A1
(43) Pub. Date: Apr. 7, 2005

(54) Cartridge type stationery product

(75) Inventors: Hidehei Kageyama, Kawagoe-shi (JP); Tadao Odaka, Kawagoe-shi (JP)

Correspondence Address: MCGINN & GIBB, PLLC, 8321 OLD COURTHOUSE ROAD, SUITE 200, VIENNA, VA, 22182-3817, US

(73) Assignee: Kotobuki & Co., Ltd., Kyoto-shi (JP)

(21) Appl. No.: 10/896,024

(22) Filed: Jul. 22, 2004

(30) Foreign Application Priority Data
Sep. 24, 2003 (JP) 2003-331655

(51) Int. Cl. B43K 29/00

(52) U.S. Cl. 401/195

(57) ABSTRACT

In a cartridge type stationery product including a body and a cartridge attachable to and detachable from the body, the cartridge is capable of being inserted from an opening of the body, a locking groove is formed on the body, and a locking protrusion which is inserted into the locking groove is formed on the cartridge, and the locking groove is constructed by a first groove portion extending in an axial direction from a vicinity of the opening, and a second groove portion extending from the first groove portion to form an angle with the first groove portion.

### BACKGROUND OF THE INVENTION

1. Field of the Invention

The present invention relates to a cartridge type stationery product including an attachable and detachable cartridge.

2. Description of the Related Art

Conventionally, as a cartridge type stationery product of this kind, there is the one described in Japanese Patent Laid-Open No. 10-81099 and shown in FIG. 11. The one described in Japanese Patent Laid-Open No. 10-81099 is a correction tape coating tool, and as shown in FIG. 11, the correction tape coating tool is constructed by a body 50, and a cartridge 60 which is attachable and detachable to and from the body 50, and is a disposable and replaceable component. The cartridge 60 is inserted into the body 50 from a rear end opening 50a which is formed at a rear end of the body 50, and a use tip end portion 60a made available for use of the cartridge 60 projects from a tip end opening 50b which is formed at a tip end of the body 50. An elastic protuberance 60b of this cartridge 60 is locked at a locking hole 50c which is formed in the vicinity of the rear end opening 50a. The cartridge 60 can be detached from the body 50 by pressing a pair of elastic arm portions 60c provided at both ends of the cartridge 60 in the opposing directions to each other, and pulling the cartridge 60 from the body 50 while releasing the locking of the elastic protuberance 60b from the locking hole 50c.

However, the cartridge 60 is housed in the body 50 by locking of the elastic protuberance 60b in the locking hole 50c, if a restoring force of the elastic arm portion 60c is weak, the cartridge 60 is likely to be detached from the body 50 unexpectedly. In order to form the elastic arm portion 60c at the cartridge 60, it is necessary to provide a clearance for the elastic arm portion 60c to swing between the elastic arm portion 60c and the other portions of the cartridge 60, and as a result, there arises the problem that the real net capacity of the cartridge 60 is limited. Especially when the capacity of the body 50 in which the cartridge 60 should be housed is small, the net capacity of the cartridge 60 is more limited.

### SUMMARY OF THE INVENTION

The present invention is made in view of the above problems, and an object of the present invention is to provide a cartridge type stationery product in which a cartridge is not unexpectedly detached and the capacity of the cartridge can be taken large, in the cartridge type stationery product.

In order to achieve the object, a cartridge type stationery product according to the present invention includes a body and a cartridge attachable to and detachable from the body, characterized in that the cartridge is capable of being inserted from an opening of the body, a locking groove is formed on one of the cartridge and the body, and a locking protrusion which is adapted to be inserted into the locking groove is formed on the other of the cartridge and the body, and the locking groove comprises a first groove portion extending from a vicinity of the opening in a cartridge insertion direction, and a second groove portion extending from the first groove portion so as to form an angle with the first groove portion.

According to the present invention, on mounting the cartridge into the body, when the cartridge is inserted with respect to the body as the locking protrusion is inserted into the locking groove, the locking protrusion moves in the first groove portion, and after the locking protrusion reaches the end portion of the first groove portion, the cartridge is twisted and rotated with respect to the body, whereby the locking protrusion moves to the second groove portion. When the locking protrusion moves to the second groove portion, the cartridge cannot be moved even if the cartridge is tried to move in the both directions of the insertion direction with respect to the body, and thereby the cartridge can be mounted into the body reliably. When the cartridge is detached from the body, the reverse operation is performed. The cartridge is not easily detached from the body because such twist, namely, rotating manipulation is required. The cartridge is fixed to the body by the locking of the locking groove and the locking protrusion, and since an elastic arm portion is not used, the clearance for the elastic arm portion to swing can be made unnecessary, thus making it possible to take the net capacity of the cartridge large.

A cap can be detachably attached to a use tip end portion which is projected from the body of the cartridge. The cartridge can be prevented from being detached unexpectedly when the cap is attached or detached.

The cap may be incapable of rotating with respect to the body in the attached state. Because the cap is incapable of rotating with respect to the body, the cartridge can be reliably prevented from being detached unexpectedly when the cap is attached and detached.

The cap can cover the locking groove and locking protrusion in the attached state. Since the cap covers the locking groove and the locking protrusion, the outer appearance in the cap attached state can be made favorable.

The cap can include an ear portion extending to an outside of the body in the attached state. The ear portion can be used as the manipulation portion when the cap is attached and detached, and favorable manipulability can be obtained.

The ear portion can cover the locking groove and the locking protrusion from outside. Since the ear portion of the cap covers the locking groove and the locking protrusion, the outer appearance in the cap fitted state can be made favorable.

In one of the cartridge and the body on which the locking groove is formed, an opening may be formed in the vicinity of the second groove portion. When the locking protrusion moves to the second groove portion, the opening in the vicinity of the second groove portion is contracted, and the locking protrusion can move by pushing and widening the second groove portion instead. As a result, the groove width at the boundary portion between the first groove portion and the second groove portion, or the groove width of the second groove portion can be set to be small with respect to the locking protrusion, and thereby it is made possible to give manipulation feeling to the user. The locking protrusion can be fitted into the second groove portion.

A narrow width portion whose groove width may be smaller than an outer diameter of the locking protrusion is formed at a boundary portion between the first groove portion and the second groove portion. When the locking protrusion is moved from the first groove portion to the second groove portion, manipulation feeling can be given, and it is made possible to notify the user that the locking protrusion enters the second groove portion reliably. It is also possible to prevent the locking protrusion from releasing from the second groove portion to the first groove portion unexpectedly.

A cushion portion can be provided between an insertion end of the cartridge and an internal part of the body, so that the cartridge is biased in a releasing direction from the body by the cushion portion. Even if the dimensional difference exists between the locking protrusion and the locking groove in the locking state, both of the locking protrusion and the locking groove are biased to abut to each other by the cushion portion, and therefore rattling can be prevented.

The cushion portion of the invention can be formed integrally at the insertion end of the cartridge. An increase in the number of components can be prevented. Alternatively, the cushion portion can be a spring interposed between the insertion end of the cartridge and the internal part of the body.

The present disclosure relates to subject manner contained in Japanese Patent Application No. 2003-331655, filed on Sep. 24, 2003, which is expressly incorporated herein by reference in its entirety.

### BRIEF DESCRIPTION OF THE DRAWINGS

FIG. 1 is an overall view of a cartridge type stationery product according to the present invention;

FIG. 2 is an overall view showing a state in which a cap in FIG. 1 is separated from a body and a cartridge;

FIG. 3 is a longitudinal cross-sectional view of the cartridge type stationery product in FIG. 1;

FIG. 4 is an exploded perspective view of the cartridge type stationery product according to the present invention;

FIG. 5A is a side view of the body, FIG. 5B is a longitudinal cross-sectional view, and FIG. 5C is a longitudinal cross-sectional view seen from the reverse direction from FIG. 5B;

FIG. 6 is a side view of a cartridge;

FIG. 7A is a side view of a cap, and FIG. 7B is a longitudinal cross-sectional view;

FIG. 8 is an exploded perspective view of a projecting and retracting mechanism (as for a third barrel and a cam body, a perspective view with a half of them being removed);

FIG. 9 is a longitudinal cross-sectional view showing another embodiment of the present invention;

FIG. 10 is a side view of a cartridge of still another embodiment of the present invention; and

FIG. 11 is an exploded perspective view of a conventional cartridge type stationery product.

### DETAILED DESCRIPTION OF THE PREFERRED EMBODIMENTS

Hereinafter, embodiments of the present invention will be explained referring to the drawings.

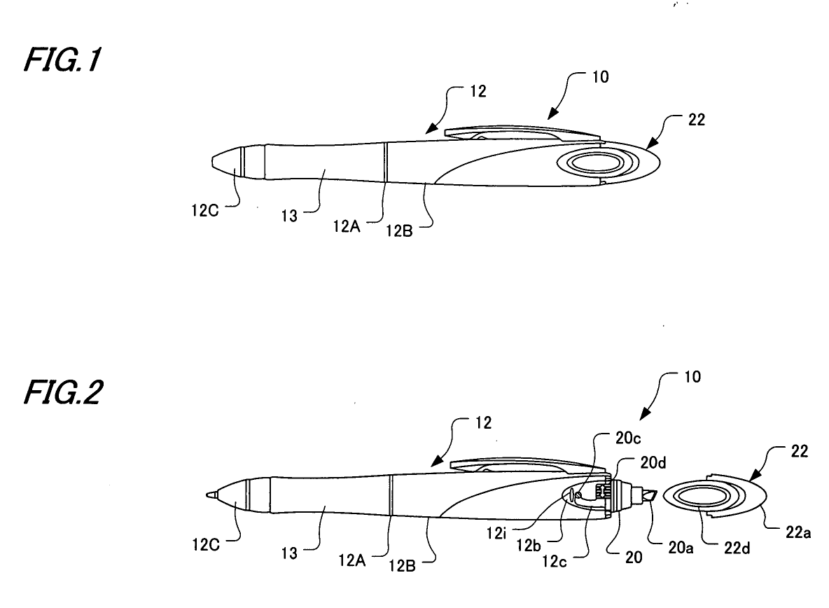

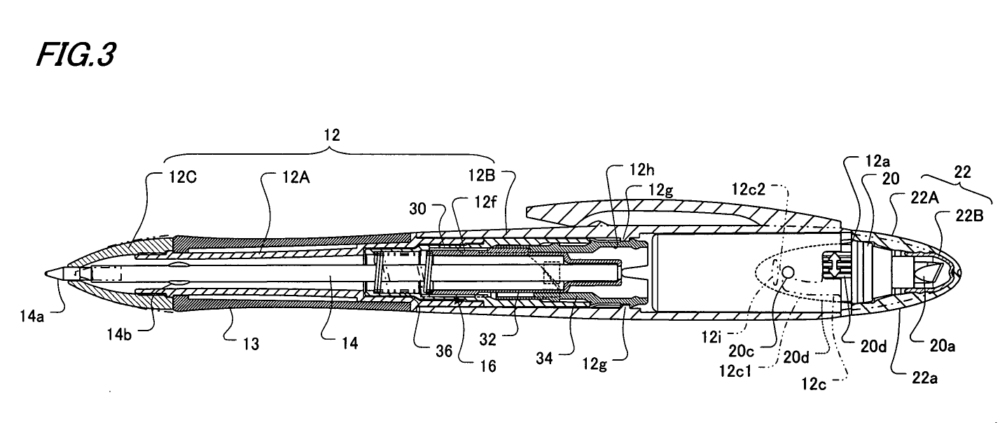

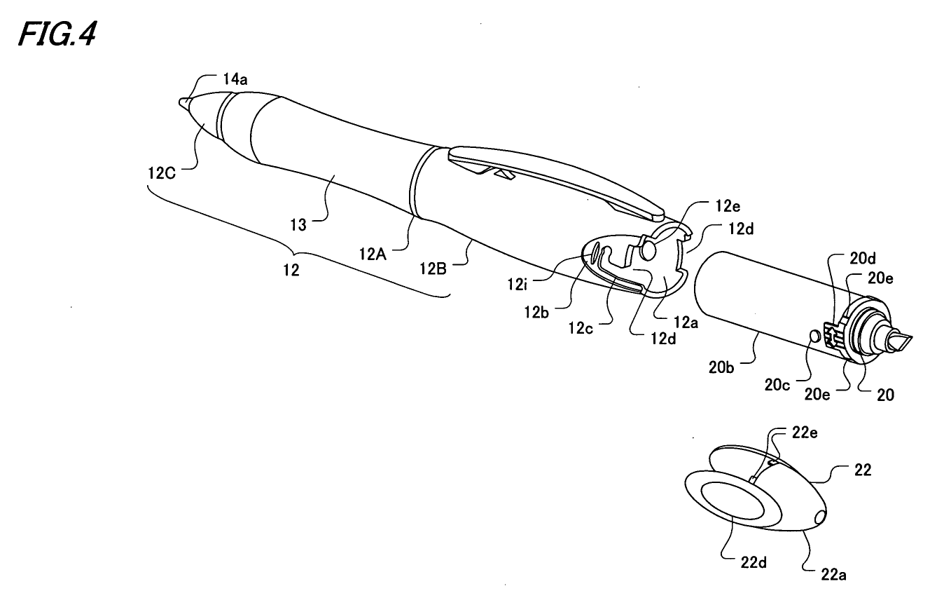

FIG. 1 is an overall view of a cartridge type stationery product according to the present invention, and FIG. 2 is a view showing a state in which a cap is separated from a body and a cartridge. In the drawings, a cartridge type stationery product 10 has a body 12 constructing a writing instrument and a cartridge 20 of a stationery product attachable to and detachable from the body 12. A use (writing) tip end portion 14a of a ball point pen refill 14 (see FIG. 3) which is housed inside the body 12 is projected from one end portion of the body 12, and a use tip end portion 20a of the cartridge 20 which is inserted into the body 12 is projected from the other end of the body 12.

In the following explanation, the explanation is made with the cartridge 20 mainly, and the side on which the use tip end portion 20a of the cartridge 20 is projected is referred to be a foremost side (front side) while the side on which the use tip end portion 14a of the ball point pen refill 14 is projected is referred to be a rear side.

In the case of this example, the cartridge 20 is a marker tool, but the cartridge 20 is not limited to this, and the cartridge 20 can be any replaceable and refillable cartridge of a stationery product such as a correction, adhesive or fluorescent highlighter tape coating tool.

A body 12 has a first barrel 12A, a second barrel 12B and a taper barrel 12C which are connected to one another to construct one barrel. An elastic grip 13 is attached to an outer peripheral surface of the first barrel 12A. It is possible to construct the first barrel 12A and the taper barrel 12C integrally, but in this example, the first barrel 12A and the taper barrel 12C are attachably and detachably screwed in each other.

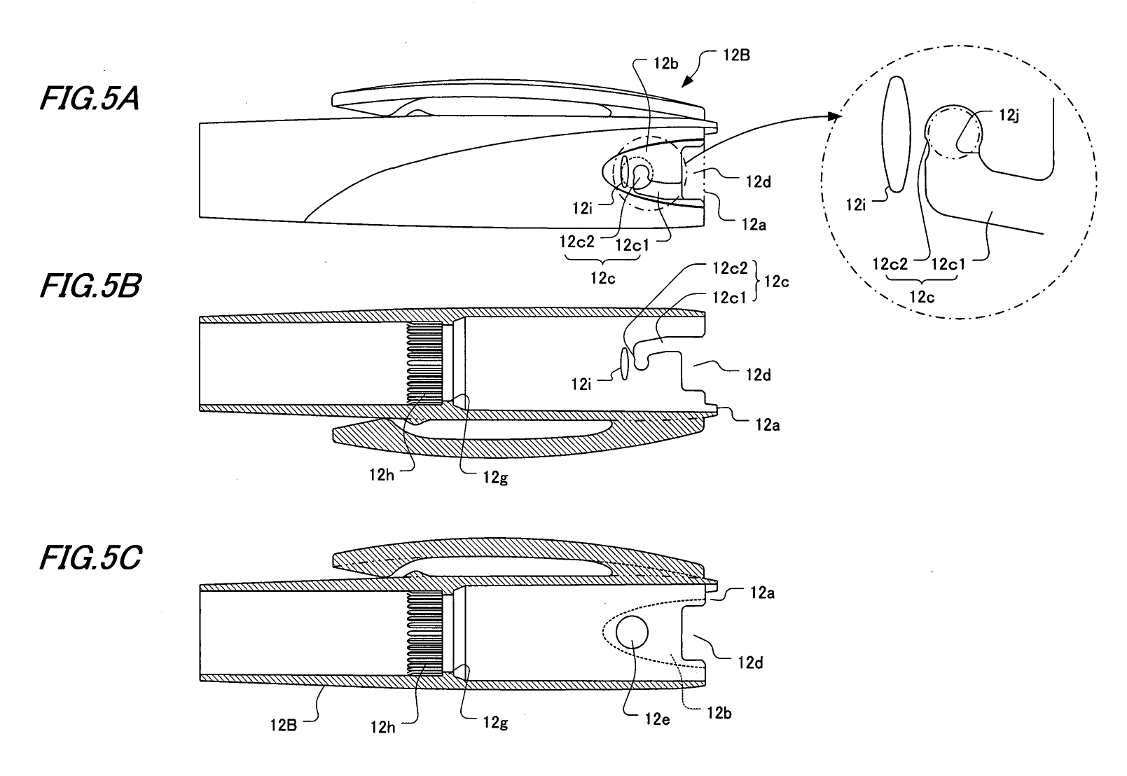

As shown in FIGS. 5A, 5B and 5C, at a side surface portion of a tip end of the second barrel 12B of the body 12, a pair of semi-elliptical thin portions 12b and 12b opposing to each other are formed in the vicinity of a tip end opening 12a, and a notch 12d and a locking groove 12c are formed in one of the thin portions 12b. The locking groove 12c is comprised of a first groove portion 12c1 extending in an axial direction from the notch 12d in the vicinity of the tip end opening 12a to the rear, and a second groove portion 12c2 which is connected to a rear end of the first groove 12c1 and forms an angle with the first groove portion 12c1. The first groove portion 12c1 extends in an insertion direction of the cartridge 20, namely, in an approximately axial direction of the cartridge 20, but “the insertion direction” here may not strictly correspond to the axial direction, and it also includes the direction having a small angle with respect to the axial direction, as shown in the drawing. On the other hand, a significant angle difference exists between the second groove portion 12c2 and the first groove portion 12c1 instead of a small difference. In this example, the second groove portion 12c2 extends in the direction approximately perpendicular to the axial direction. It is preferable that a boundary portion of the first groove portion 12c1 and the second groove portion 12c2 becomes a narrow width portion 12j. The narrow width portion 12j can be formed by expanding both sides of the groove.

Furthermore, in the one thin portion 12b, an opening 12i is formed in parallel with the second groove portion 12c2. The opening 12i is not limited to the closed opening as shown in the drawing, but may extend to the notch 12d or the like to open.

A notch 12d and a manipulation window 12e for having an access to the cartridge 20 which is inserted into the body 12 if necessary are formed in the other thin portion 12b.

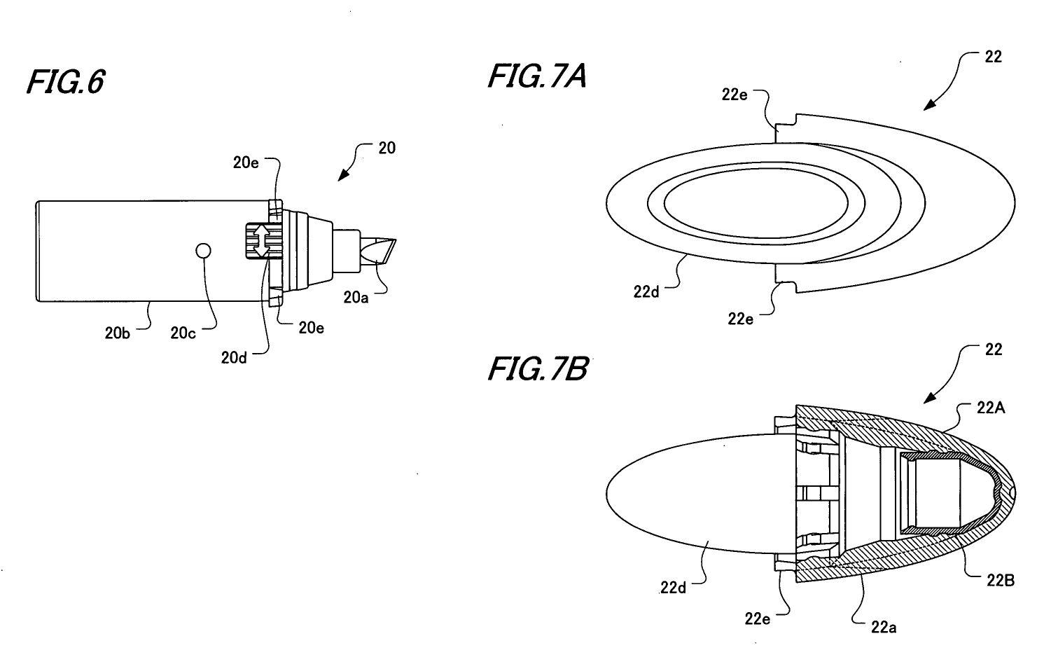

As shown in FIG. 6, on a side surface portion of a case 20b of the cartridge 20, a locking protrusion 20c which is inserted into the locking groove 12c is formed, a pair of releasing buttons 20d and 20d which are inserted into a pair of notches 12d and 12d of the body 12 and are to be manipulated to move the locking protrusion 20c are formed, and further engaging recessed portions 20e and 20e are formed adjacently to the releasing buttons 20d and 20d in the circumferential direction. Corrugation and an arrow indicating the manipulation direction are provided on the surface of the releasing buttons 20d to facilitate the manipulation.

A cap 22 for protecting the use tip end portion 20a of the cartridge 20 when it is not used is fitted on the cartridge 20. The cap 22 is constructed by an outer cap 22A and an inner cap 22B as shown in FIGS. 7A and 7B. The outer cap 22A has a cap body 22a, a pair of ear portions 22d and 22d which are formed on a side surface portion of the cap body 22a and extend rearward, and protrusions 22e and 22e placed on both sides of the ear portions 22d and 22d. The cap body 22a envelops the use tip end portion 20a together with the inner cap 22B, and is enabled to be fitted in an annular groove formed in the vicinity of the use tip end portion 20a of the cartridge 20. It is preferable that the outer cap 22A is constructed by a molded product of comparatively hard plastic and that the inner cap 22B is constructed by a molding product of comparatively soft plastic, such as polypropylene, polyethylene resin, for example, and thereby the soft inner cap 22B is in close contact with a periphery of the use tip end portion 20a of the cartridge 20 to be able to secure air tightness.

The ear portions 22d and 22d extend to an outside of the body 12 to cover the thin portions 12b and 12b of the body 12 from outside, in the fitted state in which the cap 22 is fitted on the cartridge 20. Namely, one of the ear portions 22d covers the locking groove 12c and the locking protrusion 20c which is inserted into the locking groove 12c, and the other ear portion 22d covers the manipulation window 12e. It is preferable that a corrugation, a mark, a pattern and the like are provided on the surfaces of the ear portions 22d and 22d to provide favorable manipulability.

The protrusions 22e and 22e are inserted into the engaging recessed portions 20e and 20e of the cartridge 20 in the fitted state in which the cap 22 is fitted onto the cartridge 20.

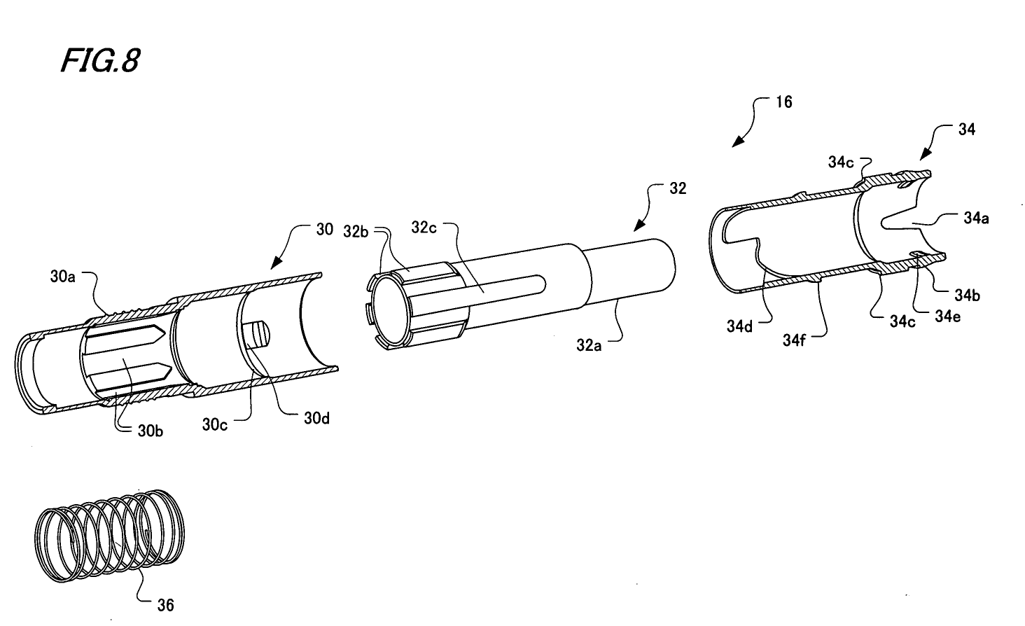

Next, a projecting and retracting mechanism 16 for projecting and retracting the ballpoint pen refill 14 is placed inside the body 12 constructing the writing instrument. As shown in FIG. 8, the projecting and retracting mechanism 16 is constructed by a third barrel 30 connected to the first barrel 12A, a slide cam 32 connected to a terminal end portion of the refill 14, a cam body 34 which is fixed to an inner peripheral surface of the second barrel 12B and moves the slide cam 32 in the axial direction, and a return spring 36.

In the third barrel 30, a male threaded portion 30a for being screwed into a female threaded portion 12f (see FIG. 3) of the first barrel 12A is formed on a part of an outer peripheral surface of the third barrel 30, and a plurality of key grooves 30b are formed on an inner peripheral surface of the third barrel 30. A step portion 30c is formed on an inner peripheral surface of the third barrel 30, and an opening 30d is formed adjacently to the step portion 30c.

In the slide cam 32, a reduced diameter portion 32a into which the terminal end portion of the refill 14 is inserted and integrally connected is formed on one end portion of the slide cam 32, and a plurality of keys 32b engaged with the key grooves 30b of the third barrel 30 and one cam protrusion 32c are formed on a part of an outer peripheral surface of the slide cam 32.

In the cam body 34, a slit 34a is formed at one end portion, a circumferential protrusion 34b is formed on an outer peripheral surface where the slit 34a is not formed to overlap the slit 34a, a plurality of keys 34c are formed on the outer peripheral surface adjacent to the circumferential protrusion 34b, and an annular protrusion 34f is formed on the outer peripheral surface spaced apart from the keys 34c. A cam surface 34d for moving the slide cam 32 in the longitudinal direction is formed on an inner peripheral surface of the cam body 34. A small protrusion 34e by undercutting is formed on a portion of the inner peripheral surface of the cam body 34, which is near the cartridge.

The return spring 36 is interposed between the front end portion of the third barrel 30 and the slide cam 32 in order to urge the slide cam 32 and the ball point pen refill 14 connected to the slide cam 32 to the rear. However, it is possible to provide the return spring 36 between a step portion inside the taper barrel 12C and a spring receiving portion 14b formed on the ball point pen refill 14, instead of this position.

The above third barrel 30, slide cam 32, cam body 34 and return spring 36 are assembled as follows. First, a part of the slide cam 32 is inserted into the cam body 34 in a manner that an end portion of the cam protrusion 32c of the slide cam 32 abuts against the cam surface 34d of the cam body 34. The return spring 36 is inserted into the third barrel 30. In this state, parts of the slide cam 32 and the cam body 34 are inserted into the third barrel 30, then, the annular protrusion 34f of the cam body 34 is inserted between the step portion 30c of the third barrel 30 and the end edge of the opening 30d, thereby the cam body 34 is locked to be relatively rotatable with respect to the third barrel 30. At the same time, the keys 32b of the slide cam 32 are fitted in the key grooves 30b of the third barrel 30. The slide cam 32 is inserted between the third barrel 30 and the cam body 34 inside the third barrel 30 and mounted so as to rotate integrally with the third barrel 30, and the projecting and retracting mechanism 16 made up of these third barrel 30, slide cam 32, cam body 34 and return spring 36 becomes a projecting and retracing unit which is integrally unitized.

The projecting and retracting unit is inserted into the second barrel 12B, and thereby the circumferential protrusion 34b of the cam body 34 is locked at a step portion 12g (FIGS. 5B and 5C) formed in the second barrel 12B. At this time, the keys 34c of the cam body 34 are fitted in any of a number of key grooves 12h formed on the second barrel 12B simultaneously, so that the cam body 34 rotates integrally with the second barrel 12B. The slit 34a of the cam body 34 is to compress one end portion of the cam body 34 when the circumferential protrusion 34b passes over the step portion 12b of the second barrel 12B upon assembly. The step portions 12g and the key grooves 12h of the second barrel 12B are interposed between the cam body 34 and the third barrel 30 of this projecting and retracting unit, whereby the projecting and retracting unit is attached to the second barrel 12B.

The male threaded portion 30a of the third barrel 30 in the projecting and retracting unit screws into the female threaded portion 12f of the first barrel 12A, whereby the first barrel 12A and the second barrel 12B are connected. When the second barrel 12B is rotated with respect to the first barrel 12A, relative rotation occurs between the cam body 34 rotating integrally with the second barrel 12B and the slide cam 32 rotating integrally with the third barrel 30 screwed into the first barrel 12A, and the cam protrusion 32c of the slide cam 32 moves along the cam surface 34d of the cam body 34, whereby the slide cam 32 moves in the axial direction. The refill 14 integrally connected to the slide cam 32 projects from the tip end of the taper barrel 12C against the spring force of the return spring 36, or retracts into the taper barrel 12C with the help of the spring force of the return spring 36, in accordance with the rotating direction of the second barrel 12B with respect to the first barrel 12A.

In the cartridge type stationery product 10 constructed as above, when the cartridge 20 is set in the body 12, the cartridge 20 is inserted into the tip end opening 12a of the second barrel 12B of the body 12. After the locking protrusion 20c of the cartridge 20 is inserted into the first groove portion 12c1 of the locking groove 12c of the second barrel 12B and moved to the end portion of the first groove portion 12c1, the cartridge 20 is twisted and rotated with respect to the body 12, and then, the locking protrusion 20c is moved to the second groove portion 12c2. At this time, resistance is given to the insertion of the locking protrusion 20c by the narrow width portion 12J existing at the boundary portion of the first groove portion 12c1 and the second groove portion 12c2, and the resistance becomes the manipulation feeling, which can notify a user that the cartridge 20 is reliably set in the body 12. When the locking protrusion 20c moves to the second groove portion 12c2, the opening 12i in the vicinity of the second groove portion 12c2 contracts to make it possible to move the locking protrusion by pushing and widening the narrow width portion 12; and the second groove portion 12c2. As a result, the groove width of the narrow width portion 121 and the second groove portion 12c2 can be set to be small enough relative to the locking protrusion 20c, and the locking protrusion 20c is fitted into the second groove portion 12c2, so that the locking protrusion 20c cannot be unexpectedly detached from the second groove portion 12c2.

After the cartridge 20 is set in the body 12, the cap 22 is attached to the cartridge 20. The protrusions 22e and 22e of the cap 22 abut against the vertical wall edge in the vicinity of the tip end opening 12a of the body 12, so that the cap 22 becomes incapable of rotating with respect to the body 12. Accordingly, the cap 22 cannot rotate with respect to the body 12 in the state in which the cap 22 is attached to on the cartridge, and therefore the cartridge 20 to which the cap 22 is attached does not rotate with respect to the body 12 following the movement at the time of attaching and detaching of the cap 22. The ear portions 22d of the cap 22 cover the locking protrusion 20c, the locking groove 12c and the releasing buttons 20d in the state in which the cap 22 is attached to the cartridge, in addition to which, the cap 22 covers all the portions of the cartridge 20, which are exposed from the body 12, and direct access to the cartridge 20 is impossible. Accordingly, in the state in which the cap 22 is attached to the cartridge, the cartridge 20 cannot be directly manipulated, and the cartridge 20 cannot be rotated with respect to the cap 22.

Next, in order to use the use tip end portion 20a of the cartridge 20, the cap 22 is pulled out, and the cap body 22a and the annular groove in the vicinity of the use tip end portion 20a are disengaged from each other. When the cap 22 is being pulled out, it is preferable that the ear portions 22d and 22d of the cap 22 are used as the manipulating portions and these are grasped and pulled out. When the ear portions 22d and 22d are moved, they are moved in the different direction from the direction in which the cartridge 20 rotates, the cartridge 20 is not unexpectedly detached.

In this manner, the use tip end portion 20a of the cartridge 20 is exposed and is available for use.

When the content of the cartridge 20 runs out and the cartridge needs to be replaced, the cap 22 is removed first. Then, after the cartridge 20 is rotated with respect to the body 12, and the locking protrusion 20c is moved to the first groove portion 12c1 from the second groove portion 12c2 of the locking groove 12c, the cartridge 20 is moved in the exact direction opposite to the insertion direction, and thereby the cartridge 20 is detached from the body 12.

As described above, in this embodiment, when the cartridge 20 is mounted in the body 12, the locking protrusion 20c is inserted into the second groove portion 12c2, and therefore even if the cartridge 20 is moved in both directions of the insertion direction with respect to the body 12, the cartridge cannot be moved, thus making it possible to reliably keep the fixed state of the cartridge 20 to the body 12. Since the elastic arm portion or the like is not formed on the cartridge 20, the cartridge 20 is not unexpectedly detached, and the vacant space inside the body 12 can be sufficiently utilized as the net capacity of the cartridge 20, thus making it possible to secure the net capacity of the cartridge 20 to be larger.

Even if the cap 22 is detached in the state in which the cap 22 is attached to the cartridge 20, the cartridge 20 does not follow the movement of the cap 22, and the cartridge 20 is not unexpectedly detached from the body 12.

The cartridge 20 is not limited to those of the same kind, but the cartridge 20 can be replaced with another cartridge of a correction, an adhesive, or a fluorescent highlighter tape coating tool.

When the ball point pen refill 14 is used, it is used by rotating the second barrel 12B with respect to the first barrel 12A. As a result, as described above, the relative rotation occurs between the slide cam 32 and the cam body 34, the cam protrusion 32c of the slide cam 32 moves along the cam surface 34d of the cam body 34, and the slide cam 32 and the ball point pen refill 14 project and retract.

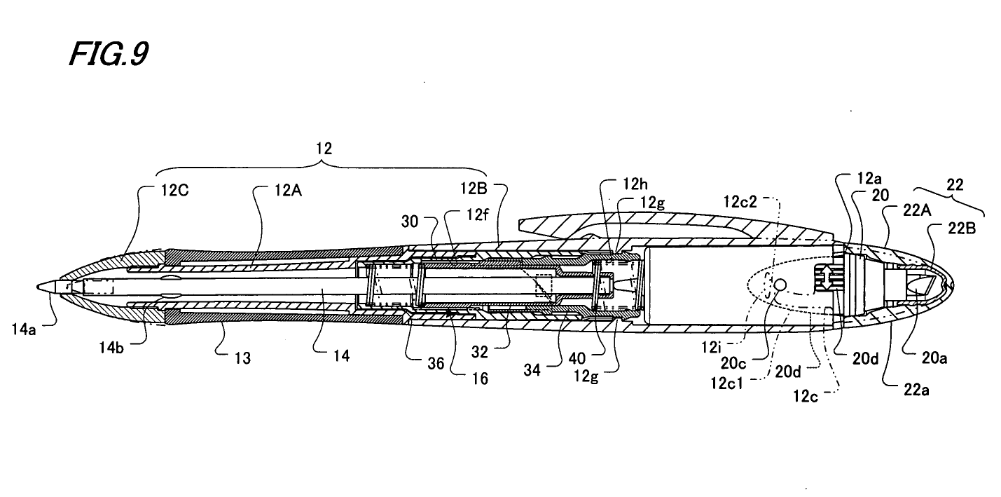

FIG. 9 shows another embodiment of the present invention. This example differs from the aforementioned embodiment in the point that a spring 40 as a cushion portion is provided between the cartridge 20 and the internal mechanism in the body 12, more specifically, between the inner peripheral step portion of the cam body 34 and the end portion of the cartridge 20. This spring 40 is interposed between the inner peripheral step portion of the cam body 34 and the end portion of the cartridge 20, and always presses the cartridge 20 to the tip end opening 12a, and in the state in which the cartridge 20 is set in the body 12, the spring 40 presses the locking protrusion 20c against the locking groove 12c, namely, inside the second groove portion 12c2 to prevent the locking protrusion 20c from rattling in the second groove portion 12c2. When the cartridge 20 is detached, the spring 40 is caught by the small protrusion 34e by undercutting formed on the cam body 34, and thereby the spring 40 is prevented from dropping. According to this embodiment, it is possible to omit the opening 12i.

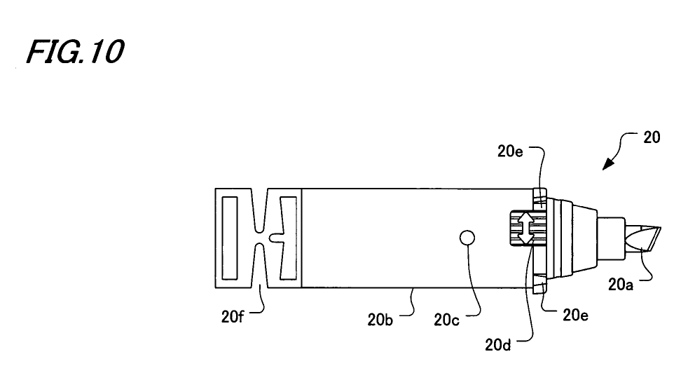

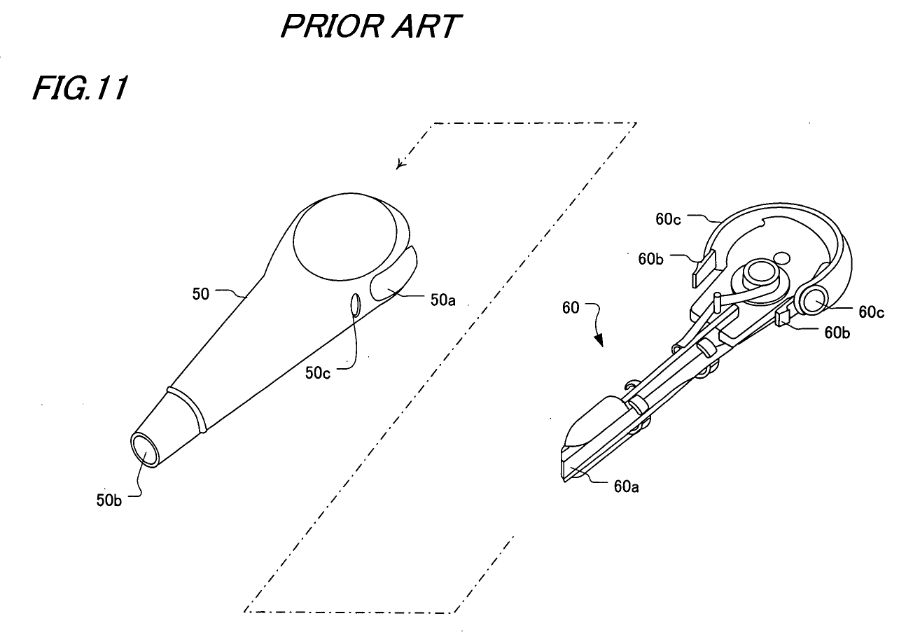

FIG. 10 shows another embodiment of the present invention. This example differs from the example in FIG. 9 in that a cushion portion 20f is integrally formed at the insertion end of the cartridge 20. The cushion portion 20f is constituted of a plurality of slits formed in the insertion end portion of the cartridge 20. The cushion portion 20f is allowed to abut against the internal mechanism inside the body 12 in this manner, whereby the same operation and effects as in the case in which the spring is provided as the cushion portion in FIG. 9 can be obtained, and since the cushion portion 20f is integrated with the cartridge 20, an increase in the number of components can be prevented.

While the principles of the invention have been described above in connection with specific embodiments, and particular modifications thereof, it is to be clearly understood that this description is made only by way of example and not as a limitation on the scope of invention.

1. A cartridge type stationery product including a body and a cartridge attachable to and detachable from the body,
wherein the cartridge is capable of being inserted from an opening of the body;
wherein a locking groove is formed on one of the cartridge and the body, and a locking protrusion which is adapted to be inserted into the locking groove is formed on the other one of the cartridge and the body; and
wherein said locking groove comprises a first groove portion extending from a vicinity of the opening in a cartridge insertion direction, and a second groove portion extending from the first groove portion so as to form an angle with the first groove portion.

2. The cartridge type stationery product according to claim 1, wherein a cap is detachably attached to a use tip end portion, which is projected from the body of the cartridge.

3. The cartridge type stationery product according to claim 2, wherein said cap is incapable of rotating with respect to the body in the attached state.

4. The cartridge type stationery product according to claim 2, wherein said cap covers said locking groove and locking protrusion in the attached state.

5. The cartridge type stationery product according to claim 2, wherein said cap includes an ear portion extending to an outside of the body in the attached state.

6. The cartridge type stationery product according to claim 5, wherein said ear portion covers said locking groove and said locking protrusion from outside.

7. The cartridge type stationery product according to claim 1, wherein in one of the cartridge and the body on which said locking groove is formed, an opening is formed in the vicinity of said second groove portion.

8. The cartridge type stationery product according to claim 1, wherein a narrow width portion whose groove width is smaller than an outer diameter of the locking protuberance is formed at a boundary portion between the first groove portion and the second groove portion.

9. The cartridge type stationery product according to claim 1, wherein a cushion portion is provided between an insertion end of the cartridge and an internal part of the body, so that the cartridge is biased in a releasing direction from the body by the cushion portion.

10. The cartridge type stationery product according to claim 9, wherein said cushion portion is formed integrally at the insertion end of the cartridge.

11. The cartridge type stationery product according to claim 9, wherein said cushion portion is a spring interposed between the insertion end of the cartridge and the internal part of the body.
